(19) United States
(12) Patent Application Publication
(10) Pub. No.: US 2024/0306238 A1
(43) Pub. Date: Sep. 12, 2024

(54) METHOD AND APPARATUS FOR DATA TRANSMISSION PROCESSING

(71) Applicant: LENOVO (BEIJING) LIMITED, Beijing (CN)

(72) Inventors: Jie Shi, Beijing (CN); Haiming Wang, Beijing (CN); Lianhai Wu, Beijing (CN); Ran Yue, Beijing (CN); Mingzeng Dai, Shanghai (CN); Jing Han, Beijing (CN)

(21) Appl. No.: 18/261,437

(22) PCT Filed: Jan. 14, 2021
(86) PCT No.: PCT/CN2021/071891

§ 371 Date: Jul. 13, 2023

(51) Int. Cl. H04W 76/18; H04W 74/0808; H04W 74/0833; H04W 76/19; H04W 76/27

(52) U.S. Cl. CPC H04W 76/18; H04W 74/0808; H04W 74/0833; H04W 76/19; H04W 76/27

(57) ABSTRACT

Embodiments of the present application are directed to a method and apparatus for data transmission processing. In an embodiment, the method includes: determining a radio link failure (RLF) happens in a small data transmission (SDT) procedure; and performing a procedure in response to the happening of the RLF in an SDT procedure.

### TECHNICAL FIELD

Embodiments of the present application generally relate to wireless communication technology, especially to a method and apparatus for data transmission processing.

### BACKGROUND

For a user equipment (UE) in RRC_INACTIVE state (also called an inactive mode UE), it is possible to transmit uplink (UL) small data to a base station (BS) over pre-configured physical uplink shared channel (PUSCH) resources (configured grant type 1 resources), or in a random access procedure, such as, a 2-step random access channel (RACH) procedure or a 4-step RACH procedure.

In a small data transmission (SDT) procedure, it has been agreed that the UE could perform the subsequent data transmission. This means that the UE could perform the physical downlink control channel (PDCCH) monitoring for scheduling information on data transmission in SDT procedure, this behavior is likely to the data transmission in UE connected mode. So, it is possible that inactive mode UE will suffer the cases defined as a radio link failure (RLF) in UE connected mode, such as by one of expiry of a timer (such as, t310-Expiry), a random access problem, maximum number of retransmission in radio link control (RLC) layer (rlc-MaxNumRetx), a beam failure recovery failure, a listen before talk (LBT) failure (such as, lbtFailure-r16). Therefore, how to make the inactive mode UE deal with the RLF to resume or reestablish the SRB or DRB in the SDT procedure due to the RLF happens needs to be discussed.

### SUMMARY OF THE APPLICATION

Embodiments of the present application provide a method and apparatus for data transmission processing.

Some embodiments of the present application provide a method performed by a user equipment (UE). The method may include: determining a radio link failure (RLF) happens in a small data transmission (SDT) procedure; and performing a procedure in response to the happening of the RLF in an SDT procedure.

In an embodiment of the present application, determining the RLF happens comprises determining at least one of the following happens: expiry of a timer; a random access problem; achieving of maximum number of retransmission in radio link control (RLC); a beam failure recovery failure; and a listen before talk (LBT) failure.

In an embodiment of the present application, the RLF happens in the SDT procedure, and performing the procedure comprises: triggering an RRC resume procedure in a non-SDT RACH procedure, triggering an RRC resume procedure in a RACH based SDT procedure or a CG based SDT procedure, triggering an RRC reestablishment procedure in a non-SDT RACH procedure, or triggering an RRC reestablishment procedure in a RACH based SDT procedure or a CG based SDT procedure.

In an embodiment of the present application, performing the procedure comprises at least one of the following: the RLF happens in a configured grant (CG) based SDT procedure, and performing the procedure comprises: triggering a random access channel (RACH) based SDT procedure, wherein the RACH based SDT procedure is a 2-step RACH based SDT procedure or a 4-step RACH based SDT procedure; the RLF happens in a 2-step RACH based SDT procedure, and performing the procedure comprises: triggering a 4-step RACH based SDT procedure; the RLF happens in a 4-step RACH based SDT procedure, and performing the procedure comprises: triggering an RRC resume procedure in a non-SDT RACH procedure or triggering an RRC reestablishment procedure in a non-SDT RACH procedure; the RLF happens in a SDT procedure, and performing the procedure comprises: triggering an RRC resume procedure in a non-SDT RACH procedure or triggering an RRC reestablishment procedure in a non-SDT RACH procedure; or the RLF happens in a SDT procedure, the UE performs fallback to following procedure in an order of priority of: a CG based SDT procedure, a 2-step RACH based SDT procedure, a 4-step RACH based SDT procedure, a 2-step RACH based procedure, a 4-step RACH based procedure if the corresponding procedure is available to the UE.

In an embodiment of the present application, triggering the RRC resume procedure in the non-SDT RACH procedure, in the RACH based SDT procedure, or in the CG based SDT procedure comprises: transmitting an RRC resume request to a serving base station (BS), wherein the RRC resume request includes an inactive-radio network temporary identifier (I-RNTI) of the UE and a resume cause value.

In an embodiment of the present application, the resume cause value includes information of at least one of the following: an RLF in SDT; a random access problem; achieving of maximum number of retransmission in RLC; a beam failure recovery failure; a listen before talk (LBT) failure; and resume or reestablish a DRB and/or SRB for SDT.

In an embodiment of the present application, the method may further include: triggering the RRC reestablishment procedure in the non-SDT RACH procedure, in the RACH based SDT procedure, or in the CG based SDT procedure comprises: transmitting an RRC reestablishment request to a serving BS, wherein the RRC reestablishment request includes an I-RNTI of the UE.

In an embodiment of the present application, a message authentication code-integrity (MAC-I) is included in the RRC reestablishment request, and is computed based on inputs of source-c-RNTI and sourcePhysCellId, wherein the source-c-RNTI is set to cell-RNTI (C-RNTI) that the UE had in the a physical cell (PCell) it was connected to prior to the reestablishment, wherein the sourcePhysCellId is set to a physical cell identity of the PCell the UE was connected to prior to the reestablishment, and the PCell is a cell the UE has service in the SDT procedure.

In an embodiment of the present application, a MAC-I is included in the RRC resume request and is transmitted based on inputs of source-c-RNTI and sourcePhysCellId, wherein the source-c-RNTI is set to C-RNTI that the UE had in a PCell it was connected in SDT procedure, or C-RNTI that the UE had in a PCell it was connected to prior to suspension of the SDT DRB, wherein the sourcePhysCellId is set to the physical cell identity of the serving Cell the UE was connected in SDT procedure, or the physical cell identity of the serving Cell the UE was connected to prior to suspension of the SDT DRB.

In an embodiment of the present application, the method may further include: storing an access category for RLF in the SDT procedure based RRC connection resumption; and performing access control by applying the access category in an RRC connection resumption procedure.

In an embodiment of the present application, the access category for RLF in the SDT procedure is a value the same as a unified access control (UAC) category of radio access network-based notification area (RNA)-updating, or the access category for RLF in the SDT procedure reuses access category of service which the UE decides to resume, or the access category for RLF in the SDT procedure reuses access category used in SDT procedure when RLF is triggered.

In an embodiment of the present application, performing the procedure comprises: transmitting a request message to request resumption or reestablishment of a data radio bearer (DRB) or a signaling radio bearer (SRB) in SDT procedure, wherein an explicit or implicit indication is included in the request message.

In an embodiment of the present application, the method may further include: staying in an inactive mode in response to a reception of a response message for the request message.

In an embodiment of the present application, the implicit indication includes a first RNTI of the UE being used in the last SDT procedure to monitor physical downlink control channel (PDCCH) and I-RNTI value in UE inactive mode.

In an embodiment of the present application, the first RNTI is a C-RNTI used in a CG based SDT procedure, a C-RNTI used in a RACH based SDT procedure, or a configured scheduling (CS)-RNTI used in an CG based SDT procedure.

In an embodiment of the present application, the method may further include: starting a timer after the request message, the RRC reestablishment request message, or the RRC resume request message is transmitted.

In an embodiment of the present application, the method may further include: entering an idle mode if the UE does not receive a response message before the timer expires, or entering an inactive mode to perform a suspend operation in an SDT procedure if the UE does not receive a response message before the timer expires.

In an embodiment of the present application, the method may further include: suspending the DRB or the SRB in SDT and entering an inactive mode; releasing the DRB or the SRB in SDT and entering an idle mode; or suspending the DRB or the SRB in SDT and sending an RRC resume request for SDT.

Some embodiments of the present application provide a method performed by a serving base station (BS) of a UE, the method may include: receiving an RRC reestablishment request message including cell ID of a last serving cell from the UE; and transmitting a request for an I-RNTI of the UE to a BS with the last serving cell in an SDT procedure based on the ID of the last serving cell, wherein the request for the I-RNTI of the UE includes a C-RNTI of the UE in the last serving cell.

In an embodiment of the present application, the method may further include: receiving the I-RNTI of the UE from the BS with last serving cell in the SDT procedure; and transmitting a retrieve UE context request message to an anchor BS by using the I-RNTI of the UE.

In an embodiment of the present application, the request for the I-RNTI of the UE is transmitted in a retrieve UE context request message implicitly with ID of the serving cell, and the C-RNTI of the UE in the last serving cell.

In an embodiment of the present application, the I-RNTI of the UE from the BS with last serving cell in the SDT procedure is received from a retrieve UE context failure message from the BS with the last serving cell.

In an embodiment of the present application, the method may further include: receiving a retrieve UE context response message from the anchor BS.

Some other embodiments of the present application provide a method. The method may include: receiving a request for an I-RNTI of the UE from a BS with serving cell, wherein the request for the I-RNTI of the UE includes a C-RNTI of the UE in the last serving BS; and transmitting the I-RNTI of the UE to the BS with serving cell based on the C-RNTI of the UE, or transmitting an indication on an RRC reestablishment request of the serving BS to an anchor BS, if the last serving BS is not the anchor BS.

In an embodiment of the present application, the I-RNTI of the UE is transmitted in a retrieve UE context failure message to the serving BS.

In an embodiment of the present application, the indication on the RRC reestablishment request of the serving BS is implicitly indicated by an ID of the serving BS, an ID of the last serving cell and the C-RNTI of the UE in the last serving BS.

In an embodiment of the present application, the indication on the RRC reestablishment request of the serving BS to the anchor BS is transmitted in a retrieve UE context request message.

Some other embodiments of the present application provide a method performed by an anchor base station (BS) of a user equipment (UE). The method may include: receiving a request message including an indication on an RRC reestablishment request of a BS with serving cell from a BS with last serving cell or the serving BS of the UE, wherein the message includes an I-RNTI of the UE; and transmitting a retrieve UE context response to the BS with serving cell.

In an embodiment of the present application, the indication on the RRC reestablishment request is implicitly included in the retrieve UE context request message.

In an embodiment of the present application, the retrieve UE context request message includes the I-RNTI in Re-establishment item, and/or includes a resume cause value.

In an embodiment of the present application, the resume cause value includes information of at least one of the following: an RLF in SDT; a random access problem; achieving of maximum number of retransmission in RLC; a beam failure recovery failure; a listen before talk (LBT) failure; and resume or reestablish a DRB and/or SRB for SDT.

Some other embodiments of the present application provide a method performed by a serving base station (BS) of a UE. The method may include: receiving an RRC request message with or without I-RNTI of the UE from the UE, and transmitting a retrieve UE context request message to an anchor BS or a BS with the last serving cell.

In an embodiment of the present application, the retrieve UE context request message includes a resume cause, and the resume cause value includes information of at least one of the following: an RLF in SDT; a random access problem; achieving of maximum number of retransmission in RLC; a beam failure recovery failure; a listen before talk (LBT) failure; and resume/reestablish a DRB and/or SRB for SDT.

In an embodiment of the present application, transmitting C-RNTI of the UE, a token and an ID of a target cell to a BS with a last serving cell in the retrieve UE context request message to the BS with the last serving cell such that the BS with the last serving BS validates the token in the RRC request message and give an validation indication on the request to the BS with the serving cell or to an anchor BS; or receiving the UE's KeNB and/or the AS algorithms used in last serving cell from an anchor BS or from the BS with the last serving cell.

In an embodiment of the present application, the method may further include: receiving a validation indication on the request from the anchor BS or from the BS with the last serving cell.

In an embodiment of the present application, the method may further include: performing validation on the RRC request based on the UE's KeNB and/or the AS algorithms used in last serving cell from an anchor BS or from the BS with the last serving cell.

In an embodiment of the present application, the method may further include: receiving an unused chaining counter parameter (NCC) information of the UE from the anchor BS or receiving an unused NCC information of the UE from the BS with the last serving cell; or receiving a used chaining counter parameter (NCC) information of the UE from the anchor BS or receiving a used NCC information of the UE from the BS with the last serving cell.

In an embodiment of the present application, the method may further include: receiving the indication on the RRC request validation from the anchor BS or from the BS with the last serving cell.

Some other embodiments of the present application provide a method performed by base station (BS) with last serving cell of a UE. The method may include at least one of the following: transmitting the UE's K_{gNB} and/or the AS algorithms used in last serving cell to an anchor BS to let the anchor BS store these information and perform the verification of a request from the UE; receiving the UE's C-RNTI, the token and target Cell-ID, in order to validate the request from the UE and to give a validation indication on the request to anchor BS; transmitting an unused chaining counter parameter (NCC) information of the UE to the anchor BS or receiving an unused NCC information of the UE from the anchor BS; transmitting a used chaining counter parameter (NCC) information of the UE to the anchor BS or receiving a used NCC information of the UE from the anchor BS; transmitting validation indication on the request to anchor BS based on the information from a BS with a serving cell or an anchor BS.

Some other embodiments of the present application provide a method performed by base station (BS) with last serving cell of a UE. The method may include at least one of the following: transmitting the UE's KgNB and/or the AS algorithms used in last serving cell to a BS with serving cell to let the BS with serving cell store and perform the verification of a request from the UE; receiving the UE's C-RNTI, the token and target Cell-ID from a BS with serving cell and validating the request from the UE and giving a validation indication on the request to the BS with serving cell; transmitting an unused chaining counter parameter (NCC) information of the UE to the anchor BS or receiving an unused NCC information of the UE from the anchor BS; transmitting a used chaining counter parameter (NCC) information of the UE to the anchor BS or receiving a used NCC information of the UE from the anchor BS; transmitting a validation indication on the request to the BS with serving cell based on the information from the BS with a serving cell or an anchor BS.

Some other embodiments of the present application provide a method performed by an anchor base station (BS) of a user equipment (UE). The method may include: receiving a retrieve UE context request message from a base station (BS) with serving cell or from the BS with last serving cell; and transmitting a retrieve UE context response message to the BS with serving cell or to the BS with last serving cell.

In an embodiment of the present application, the method may further include: receiving the UE's K^{gNB} and/or the AS algorithms used in last serving cell to let anchor BS store these information and perform the verification of a request from the UE; transmitting the UE's C-RNTI in last serving cell, token and target Cell-ID to the BS with last serving cell, in order to make the BS with last serving cell validate the request from the UE and give a validation indication on the request to the anchor BS; receiving an unused chaining counter parameter (NCC) information of the UE from the BS with last serving cell or transmitting an unused NCC information of the UE to the BS with last serving cell; receiving a used chaining counter parameter (NCC) information of the UE from the BS with last serving cell or transmitting a used NCC information of the UE to the BS with last serving cell; receiving a validation indication on the request from the BS with last serving cell.

In an embodiment of the present application, the method may further include: at least one of: transmitting the UE's KeNB and/or the AS algorithms used in last serving cell to a BS with serving cell to let the BS with serving cell store these information and perform the verification of a request from the UE; transmitting the UE's C-RNTI in last serving cell, token and target Cell-ID to the BS with last serving cell, in order to make the BS with last serving cell validate the request from the UE and give a validation indication on the request to the anchor BS; receiving an unused chaining counter parameter (NCC) information of the UE from the BS with last serving cell or transmitting an unused NCC information of the UE to the BS with last serving cell; receiving a used chaining counter parameter (NCC) information of the UE from the BS with last serving cell or transmitting a used NCC information of the UE to the BS with last serving cell; receiving a validation indication on the request from the BS with last serving cell.

In an embodiment of the present application, the UE's K_{gNB} and/or the AS algorithms could be replaced by the at least one of a prepared K_{NG-RAN}* key and token.

In order to calculate the token, the gNB shall use the negotiated NIA-algorithm from the 5G AS Security context from the gNB with the following inputs: source C-RNTI, source PCI and target Cell-ID, where source PCI and source C-RNTI are associated with the cell the UE last had an active RRC connection or SDT transmission with and target Cell-ID is the identity of the target cell where the RRCReestablishmentRequest, RRCResuemRequest, or UE request message is sent to.
KEY shall be set to K_{RRCint} of the source cell or the cell which the SDT transmission is in.
all BEARER bits shall be set to 1;
DIRECTION bit shall be set to 1;
all COUNT bits shall be set to 1.

The token shall be the 16 least significant bits of the output of the used integrity algorithm.

If the computed token for validation indication on the request based on the KEY in network side. is equal to the token in the UE request message, the request is valid. If the computed token for validation indication on the request is not equal to the token in the UE request message, the request is invalid.

In an embodiment of the present application, the method may further include: transmitting a validation indication on the request to the BS with the last serving cell or the BS with serving cell.

In an embodiment of the present application, the retrieve UE context request message includes a resume cause, and the resume cause value includes information of at least one of the following: an RLF in SDT; a random access problem; achieving of maximum number of retransmission in RLC; a beam failure recovery failure; a listen before talk (LBT) failure; and resume/reestablish e DRB and or SRB for SDT.

Some other embodiments of the present application provide an apparatus. The apparatus may include at least one non-transitory computer-readable medium having computer executable instructions stored therein; at least one receiver; at least one transmitter; and at least one processor coupled to the at least one non-transitory computer-readable medium, the at least one receiver and the at least one transmitter. The computer executable instructions are programmed to implement the above method with the at least one receiver, the at least one transmitter and the at least one processor.

Embodiments of the present application may make the inactive mode UE deal with the RLF to resume or reestablish the SRB or DRB in the SDT procedure due to the RLF happens.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a wireless communication system according to some embodiments of the present application;

FIG. 2 illustrates a flow chart of a method for information processing in an SDT procedure according to some embodiments of the present application;

FIG. 3 illustrates a flow chart of a RRC resume procedure according to some embodiments of the present application;

FIG. 4 illustrates a flow chart of a RRC reestablishment procedure according to some embodiments of the present application;

FIG. 5 illustrates a flow chart of a RRC reestablishment procedure according to some embodiments of the present application;

FIG. 6 illustrates a flow chart of a RRC reestablishment procedure according to some embodiments of the present application;

FIG. 7 illustrates a flow chart of performing security processing according to an embodiment of the present application;

FIG. 8 illustrates a flow chart of performing security processing according to another embodiment of the present application;

FIG. 9 illustrates a flow chart of performing security processing according to another embodiment of the present application;

FIG. 10 illustrates a flow chart of performing security processing according to another embodiment of the present application;

FIG. 11 illustrates a flow chart of performing security processing according to another embodiment of the present application;

FIG. 12 illustrates a flow chart of performing security processing according to another embodiment of the present application;

FIG. 13 illustrates an apparatus according to some embodiments of the present application; and

FIG. 14 illustrates another apparatus according to some other embodiments of the present application.

### DETAILED DESCRIPTION

The detailed descriptions of the appended drawings are intended as descriptions of preferred embodiments of the present application and are not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings.

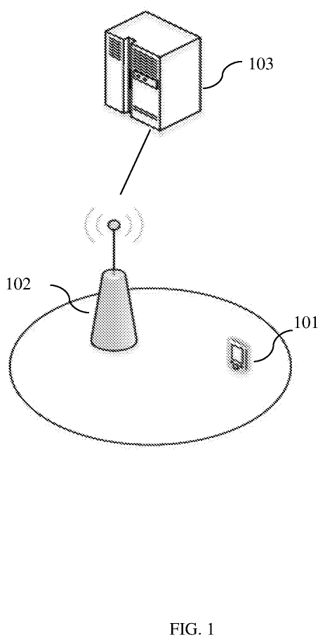

FIG. 1 illustrates a wireless communication system according to some embodiments of the present application.

As shown in FIG. 1, the wireless communication system can include at least one base station (BS) 102, at least one UE 101, and a core network (CN) node 103. Although a specific number of BSs and UEs, e.g., a BS (e.g., BS 102) and a UE (UE 101) are depicted in FIG. 1, one skilled in the art will recognize that any number of BSs and UEs may be included in the wireless communication system. As shown in FIG. 1, the BS 102 may be distributed over a geographic region and may communicate with the CN node 103 via an interface.

The UE 101 may be a computing device, such as a desktop computer, a laptop computer, a personal digital assistant (PDA), a tablet computer, a smart television (e.g., a television connected to the Internet), a set-top box, a game console, a security system (including security cameras), a vehicle on-board computer, a network device (e.g., router, switch, and modem), or the like. According to an embodiment of the present application, the UE 101 may be a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present application, the UE 101 may be a wearable device, such as a smart watch, a fitness band, an optical head-mounted display, or the like. Moreover, the UE 101 may be referred to as a subscriber unit, a mobile, a mobile station, a user, a terminal, a mobile terminal, a wireless terminal, a fixed terminal, a subscriber station, a user terminal, or a device, or described using other terminology used in the art.

The BS 102 may communicate with a CN node 103 via an interface. In some embodiments of the present application, the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally part of a radio access network that may include one or more controllers communicably coupled to one or more corresponding BS(s).

In an example, the CN node 103 can be a mobility management entity (MME) or a serving gateway (S-GW). In another embodiment of the present application, the CN node 103 may include a mobility management function (AMF) or a user plane function (UPF).

The wireless communication system may be compatible with any type of network that is capable of sending and receiving wireless communication signals. For example, the wireless communication system can be compatible with a wireless communication network, a cellular telephone network, a time division multiple access (TDMA)-based network, a code division multiple access (CDMA)-based network, an orthogonal frequency division multiple access (OFDMA)-based network, a long term evolution (LTE) network, a 3rd generation partnership project (3GPP)-based network, a 3GPP 5G network, a satellite communications network, a high altitude platform network, and/or other communications networks.

In some embodiments of the present application, the wireless communication system can be compatible with 5G new radio of the 3GPP protocol, wherein BS 102 transmits data using an OFDM modulation scheme on the downlink (DL) and UE 101 transmits data on the uplink (UL) using a single-carrier frequency division multiple access (SC-FDMA) or OFDM scheme. More generally, however, the wireless communication system may implement some other open or proprietary communication protocols, for example, WiMAX, WiFi, among other protocols.

In some embodiments of the present application, the BS 102 may communicate using other communication protocols, such as the IEEE 802.11 family of wireless communication protocols. Further, in some embodiments of the present application, the BS 102 may communicate over licensed spectrums, whereas in other embodiments the BS 102 may communicate over unlicensed spectrums. Embodiments of the present application are not intended to be limited to the implementation of any particular wireless communication system architecture or protocol. In yet some embodiments of the present application, the BS 102 may communicate with UE 101 using 3GPP 5G protocols.

In an example, the UE 101 is not in RRC_CONNECTED state, for example, the UE 101 could be in a RRC_IDLE state or in a RRC_INACTIVE state. When performing small data transmission, the UE 101 transmits packets to the BS 102, and the BS 102 transmits the small data to the CN node 103 via the interface.

Herein, the data transmission or small data transmission (SDT) may mean that a UE in an inactive state/mode or an idle state/mode could transmit the data to the network side (or network), or receive the data from the network side. The details could be as follows:

An inactive UE may have a CN connection in a cell (e.g., cell A) associated with its last serving BS (also referred to as “anchor BS”). However, in some scenarios, the inactive UE may perform data transmission via another cell (cell B). The data transmission may include at least one of an uplink data transmission and downlink data transmission. For example, the inactive UE may initiate an uplink data transmission via cell B, establish a RAN connection with cell B, enter the connected mode, and then perform the data transmission. Or, the inactive UE may initiate an uplink data transmission via cell B and still stay in inactive mode in the data transmission procedure. An idle UE may act similarly.

After the completion of the data transmission, the inactive or idle UE may receive a suspend message or release message from cell B and then go back to the inactive or idle mode. Or, after the completion of the data transmission, the inactive or idle UE may receive a suspend message or release message from cell B and the UE still stay in inactive or idle mode in the data transmission procedure. In some embodiments of the present disclosure, the suspend message or release message is an RRC message. In some embodiments of the present disclosure, the data size in such data transmission may be no larger than the maximum transport block (TB) size that can be applied in one transmission, as defined in standard protocols. Small data transmission is one of such scenarios.

Currently, a UE in inactive mode could perform a small data transmission over configured grant type 1 resources, Msg.A for 2-step RACH, or Msg.3 in normal RACH from INACTIVE state. And a work item description (WID) on small data transmission (SDT) in a RRC_INACTIVE state is as follows:
For the RRC_INACTIVE state:
   UL small data transmissions for RACH-based schemes (i.e. 2-step and 4-step RACH):
      General procedure to enable UP data transmission for small data packets from INACTIVE state (e.g. using MSGA or MSG.3) [RAN2]
      Enable flexible payload sizes larger than the Rel-16 CCCH message size that is possible currently for INACTIVE state for MSGA and MSG.3 to support UP data transmission in UL (actual payload size can be up to network configuration) [RAN2]
      Context fetch and data forwarding (with and without anchor relocation) in INACTIVE state for RACH-based solutions [RAN2, RAN3]
   Note 1: The security aspects of the above solutions should be checked with SA3 (Services & Systems Aspects 3)
   Transmission of UL data on pre-configured PUSCH resources (i.e. reusing the configured grant type 1)-when TA is valid
      General procedure for small data transmission over configured grant type 1 resources from INACTIVE state [RAN2]
      Configuration of the configured grant type1 resources for small data transmission in UL for INACTIVE state [RAN2]
No new RRC state should be introduced in this WID. Transmission of small data in UL, subsequent transmission of small data in UL and DL and the state transition decisions should be under network control. Focus of the WID should be on licensed carriers and the solutions can be reused for NR-U if applicable.
   Note 2: Any associated specification work in RAN1 that is needed to support the above set of objectives should be initiated by RAN2 via an LS.

Currently, in an SDT procedure, it has been agreed that the UE could perform the subsequent data transmission. This means that the UE could perform the PDCCH monitoring for scheduling information on data transmission in SDT procedure, this behavior is likely to the data transmission in UE connected mode. So, it is possible that inactive mode UE will suffer the cases defined as a radio link failure (RLF) in UE connected mode, such as, by one of t310-Expiry, randomAccessProblem, rlc-MaxNumRetx, beamFailureRecoveryFailure, and IbtFailure-r16. Therefore, how the inactive mode UE deals with the RLF to resume or reestablish the SRB or DRB in the SDT procedure will be discussed in the following description of the present application.

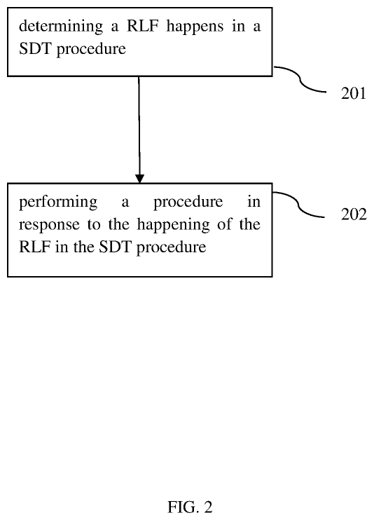

FIG. 2 illustrates a flow chart of a method for information processing in an SDT procedure according to some embodiments of the present application. The method in FIG. 2 is performed by a UE (e.g., UE 101 in FIG. 1).

As shown in FIG. 2, in step 201, the UE may determine a RLF happens in an SDT procedure. And then in step 202, the UE may perform a procedure in response to the happening of the RLF in the SDT procedure.

For example, the UE may determine the RLF happens in the SDT procedure when at least one of the following happens: expiry of a timer (such as, t310-Expiry); a random access problem; achieving of maximum number of retransmission in radio link control (RLC) (such as, rlc-MaxNumRetx); a beam failure recovery failure; and a LBT failure (such as, lbtFailure-r16).

For example, upon T310 expiry in serving Cell; or upon random access problem indication from MAC; or upon indication from RLC that the maximum number of retransmissions has been reached; or upon consistent uplink LBT failure indication from MAC; or upon a beam failure recovery failure from MAC, the UE shall consider radio link failure to be detected. Then UE shall suspend the transmission of all DRBs in the source MCG; reset MAC. The CG resource will be stored and without reset.

In order to deal with the RLF to resume or reestablish the SRB or DRB in the SDT procedure, the UE may perform at least one of the following procedures based on the actual need or requirement.

In an embodiment, if the RLF happens in an SDT procedure, the UE may trigger an RRC resume procedure in a non-SDT RACH procedure to move UE in connected mode.

In another embodiment, if the RLF happens in an SDT procedure, the UE may trigger an RRC resume procedure in a RACH based SDT procedure or a CG based SDT procedure.

In another embodiment, if the RLF happens in an SDT procedure, the UE may trigger an RRC reestablishment procedure in a non-SDT RACH procedure to move UE in connected mode.

In another embodiment, if the RLF happens in an SDT procedure, the UE may trigger an RRC reestablishment procedure in a RACH based SDT procedure or a CG based SDT procedure.

In another embodiment, if the RLF happens in a configured grant (CG) based SDT procedure, the UE may trigger a random access channel (RACH) based SDT procedure, the RACH based SDT procedure is a 2-step RACH based SDT procedure or a 4-step RACH based SDT procedure. If both the 2-step RACH based SDT procedure and the 4-step RACH based SDT procedure are available to UE, the 2-step RACH based SDT takes precedence over the 4-step RACH based SDT.

In another embodiment, if the RLF happens in a 2-step RACH based SDT procedure, the UE may trigger a 4-step RACH based SDT procedure.

In another embodiment, if the RLF happens in a 4-step RACH based SDT procedure, the UE may trigger an RRC resume procedure in a non-SDT RACH procedure to move UE in connected mode.

In another embodiment, if the RLF happens in a 4-step RACH based SDT procedure, the UE may trigger an RRC reestablishment procedure in a non-SDT RACH procedure to move UE in connected mode.

The non-SDT RACH procedure means the preamble is initiated in the non-SDT or legacy RACH resource, which could be RACH resource for 2-step RACH or 4-step RACH.

In another embodiment, if the RLF happens in a SDT procedure, the UE performs fallback to the following procedure in an order of priority of: a CG based SDT procedure, a 2-step RACH based SDT procedure, a 4-step RACH based SDT procedure, a 2-step RACH based procedure, a 4-step RACH based procedure if the corresponding procedure is available to the UE. For example, only if the CG based SDT procedure is available to the UE, the CG based SDT procedure will be selected. Otherwise, the 2-step RACH based SDT procedure with the second highest priority will be selected, and so on. The UE could perform the fallback from the procedure where it is RLF to the next procedure in the following procedure with the order of priority. For example, if UE is RLF in 2-step RACH based SDT procedure, it shall perform 4-step RACH based SDT procedure.

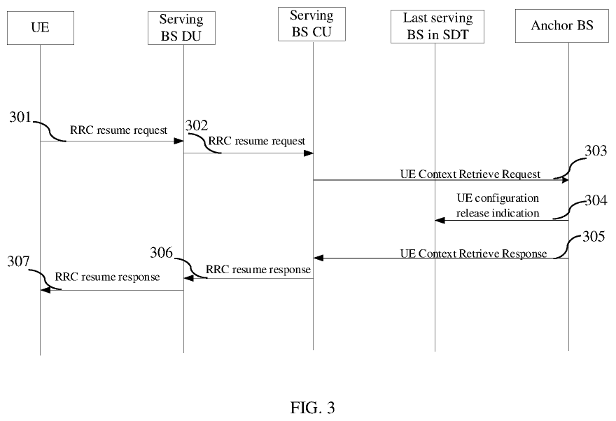

FIG. 3 illustrates a flow chart of a RRC resume procedure according to some embodiments of the present application. The RRC resume procedure is triggered in the non-SDT RACH procedure, in the RACH based SDT procedure, or in the CG based SDT procedure. The method in FIG. 3 is performed among a UE, a serving BS (including a distributed unit (DU) of the serving BS and a central unit (CU) of the serving BS), an anchor BS and a last serving BS in SDT. The serving BS indicates the BS with the serving cell. The last serving BS indicates the BS with the last serving cell.

As shown in FIG. 3, in step 301, the UE may transmit an RRC resume request to the serving BS. The RRC resume request may include an inactive-radio network temporary identifier (I-RNTI) of the UE and a resume cause value.

For example, the resume cause value may include information of at least one of an RLF in SDT; a random access problem; achieving of maximum number of retransmission in RLC; a beam failure recovery failure; a LBT failure; and resume or reestablish the DRB and/or SRB for SDT. For example, the achieving of the maximum number of retransmission is in a RLC layer, a MAC layer, or a (physical) PHY layer.

In particular, inside the serving BS, the DU of the serving BS (also called serving BS DU) receives the RRC resume request from the UE, and then in step 302 the serving BS DU transmits the RRC resume request to the CU of the serving BS (serving BS CU).

In step 303, after receiving the RRC resume request, the serving BS CU may transmits a message (such as, a UE context retrieve request message) to an anchor BS where the UE context is stored based on the I-RNTI of the UE in the RRC resume request.

A message authentication code-integrity (MAC-I) is included in the in the RRC resume request and is transmitted based on inputs of source-c-RNTI and sourcePhysCellId. The source-c-RNTI is set to C-RNTI that the UE had in a PCell it was connected in SDT procedure, or C-RNTI that the UE had in a PCell it was connected to prior to suspension of the SDT DRB. The sourcePhysCellId is set to the physical cell identity of the serving Cell the UE was connected in SDT procedure, or the physical cell identity of the serving Cell the UE was connected to prior to suspension of the SDT DRB.

The C-RNTI could be a C-RNTI used in a CG based SDT procedure, a C-RNTI used in a RACH based SDT procedure, or a configured scheduling (CS)-RNTI used in a CG based SDT procedure.

After receiving the message from the serving BS, the anchor BS may determine move the UE in the RRC connected mode and in step 305, the anchor BS may transmit an indication to let the UE move in the RRC connected mode, such as, in a UE context retrieve response message to the serving BS CU.

Furthermore, in step 304, the anchor BS may transmit a UE configuration release indication to the last serving BS in SDT where RLF happens.

In step 306, the serving BS CU may transmit a RRC resume response including the indication to let the UE move in the RRC connected mode to the serving BS DU. And then in step 307, the serving BS DU transmits the RRC resume response to the UE. After receiving the RRC response message from the serving BS DU, the UE may enter the RRC connected mode.

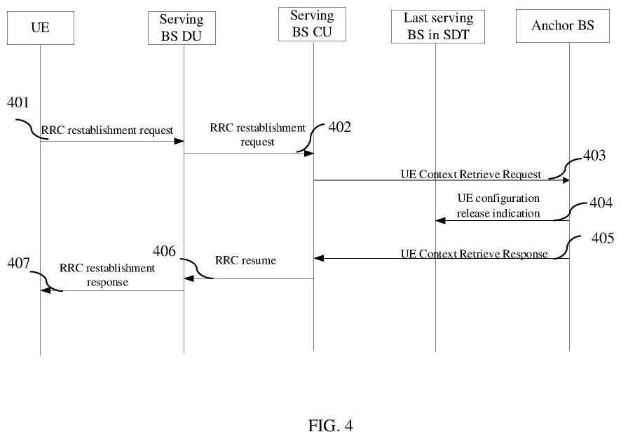

FIG. 4 illustrates a flow chart of a RRC reestablishment procedure according to some embodiments of the present application. The RRC reestablishment procedure is triggered in the non-SDT RACH procedure, in the RACH based SDT procedure, or in the CG based SDT procedure. The method in FIG. 4 is performed among a UE, a serving BS (including a distributed unit (DU) of the serving BS and a central unit (CU) of the serving BS), an anchor BS and a last serving BS in SDT. The serving BS indicates the BS with the serving cell. The last serving BS indicates the BS with the last serving cell.

As shown in FIG. 4, in step 401, the UE may transmit an RRC reestablishment request to the serving BS. The RRC reestablishment request may include an I-RNTI of the UE. For example, the I-RNTI may be a short I-RNTI or a full I-RNTI.

In addition, the RRC reestablishment request may further include other information, such as, a cell-radio network temporary identifier (C-RNTI) of the UE, and a physical cell (PCell) ID in the SDT procedure. The C-RNTI of the UE could be the C-RNTI in a RACH based SDT procedure, in a non-SDT RACH procedure, or in a CG based SDT procedure.

A message authentication code-integrity (MAC-I) is included in the RRC reestablishment request, and is computed based on inputs of source-c-RNTI and sourcePhysCellId. The source-c-RNTI is set to cell-RNTI (C-RNTI) that the UE had in the a physical cell (PCell) it was connected to prior to the reestablishment, and the sourcePhysCellId is set to a physical cell identity of the PCell the UE was connected to prior to the reestablishment. The PCell could be a cell the UE has service in the SDT procedure. The C-RNTI could be a C-RNTI used in a CG based SDT procedure, a C-RNTI used in a RACH based SDT procedure, or a configured scheduling (CS)-RNTI used in a CG based SDT procedure.

In particular, inside the serving BS, the DU of the serving BS (also called serving BS DU) receives the RRC reestablishment request from the UE, and then in step 402 the serving BS DU transmits the RRC reestablishment request to the CU of the serving BS (serving BS CU).

In step 403, after receiving the RRC resume request, the serving BS CU may transmits a message (such as, a UE context retrieve request message) to an anchor BS where the UE context is stored based on the I-RNTI of the UE in the RRC resume request. The message may include the I-RNTI information, the C-RNTI and paging-RNTI (P-RNTI) in SDT procedure.

After receiving the message from the serving BS, the anchor BS may determine move the UE in the RRC connected mode and in step 405, the anchor BS may transmit an indication to let the UE move in the RRC connected mode, such as, in a UE context retrieve response message to the serving BS CU.

Furthermore, in step 404, the anchor BS may transmit a UE configuration release indication to the last serving BS in SDT where RLF happens.

In step 406, the serving BS CU may transmit a RRC resume including the indication to let the UE move in the RRC connected mode to the serving BS DU. And then in step 407, the serving BS DU transmits a RRC reestablishment response to the UE. After receiving the RRC reestablishment response from the serving BS DU, the UE may enter the RRC connected mode.

Unlike the above RRC reestablishment procedure (the RRC reestablishment request includes an I-RNTI of the UE), in some other embodiments of the present application, the legacy RRC reestablishment request message may be used and transmitted to the serving BS.

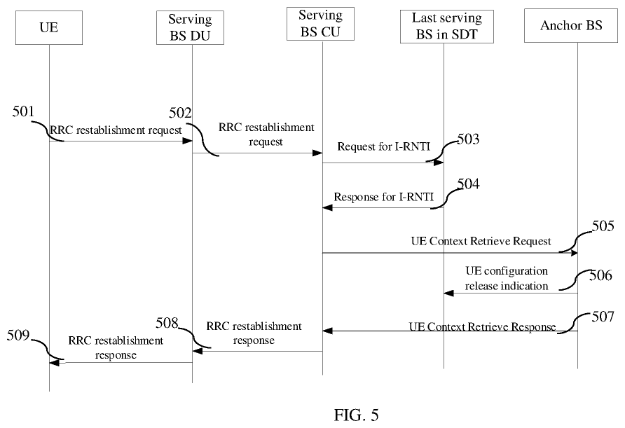

FIG. 5 illustrates a flow chart of a RRC reestablishment procedure according to some embodiments of the present application. The RRC reestablishment procedure is triggered in the non-SDT RACH procedure, in the RACH based SDT procedure, or in the CG based SDT procedure. The method in FIG. 5 is performed among a UE, a serving BS (including a distributed unit (DU) of the serving BS and a central unit (CU) of the serving BS), an anchor BS and a last serving BS in SDT. The serving BS indicates the BS with the serving cell. The last serving BS indicates the BS with the last serving cell.

As shown in FIG. 5, in step 501, the UE may transmit an RRC reestablishment request to the serving BS. The RRC reestablishment request may include a cell-radio network temporary identifier (C-RNTI) of the UE, and a physical cell (PCell) ID in the SDT procedure. The PCell ID is the cell ID of the last serving cell. The C-RNTI of the UE could be the C-RNTI in a RACH based SDT procedure, in a non-SDT RACH procedure, or in a CG based SDT procedure.

In particular, inside the serving BS, the DU of the serving BS (also called serving BS DU) receives the RRC reestablishment request from the UE, and then in step 502 the serving BS DU transmits the RRC reestablishment request to the CU of the serving BS (serving BS CU).

In step 503, after receiving the RRC resume request, the serving BS CU may transmits a request for an I-RNTI of the UE to the last serving BS in SDT (that is, a BS with the last serving cell in an SDT procedure) based on the ID of the last serving cell (PCell ID). The request for the I-RNTI of the UE includes a C-RNTI of the UE in the last serving cell and the PCell ID. The last serving cell is the cell where the UE performed the SDT procedure.

And then in step 504, after receiving the request for the I-RNTI of the UE, the BS with last serving cell in the SDT procedure (the last serving BS in SDT) transmits the I-RNTI of the UE to the serving BS (the serving BS CU) by transmitting a response.

For example, the request for the I-RNTI of the UE may be transmitted in a retrieve UE context request message implicitly with ID of the serving cell, and the C-RNTI of the UE in the last serving cell. Furthermore, the retrieve UE context request message may further include the cell ID of the last serving cell and/or resume cause value. The resume cause value could be at least one of an RLF in SDT; a random access problem; achieving of maximum number of retransmission in RLC; a beam failure recovery failure; a listen before talk (LBT) failure; and resume/reestablish the SDT DRB and/or SRB. In another example, the retrieve UE context request message may include null I-RNTI information.

In another embodiment, the serving BS may receive the the I-RNTI of the UE from the BS with last serving cell in the SDT procedure from a retrieve UE context failure message from the BS with the last serving cell (the last serving BS in SDT).

In step 505, the serving BS (the serving BS CU) transmits a retrieve UE context request message (such as, UE Context Retrieve Request in FIG. 5) to an anchor BS where the UE context is stored by using the I-RNTI of the UE. For example, the I-RNTI of the UE is added in the reestablishment IE of the retrieve UE context request message.

After receiving the message from the serving BS, the anchor BS may determine move the UE in the RRC connected mode and in step 507, the anchor BS may transmit an indication to let the UE move in the RRC connected mode, such as, in a retrieve UE context response message (such as, UE Context Retrieve Response in FIG. 5) to the serving BS CU.

Furthermore, in step 506, the anchor BS may transmit a UE configuration release indication to the last serving BS in SDT where RLF happens.

In step 508, the serving BS CU may transmit a RRC resume including the indication to let the UE move in the RRC connected mode to the serving BS DU. And then in step 509, the serving BS DU transmits a RRC reestablishment response to the UE. After receiving the RRC reestablishment response from the serving BS DU, the UE may enter the RRC connected mode.

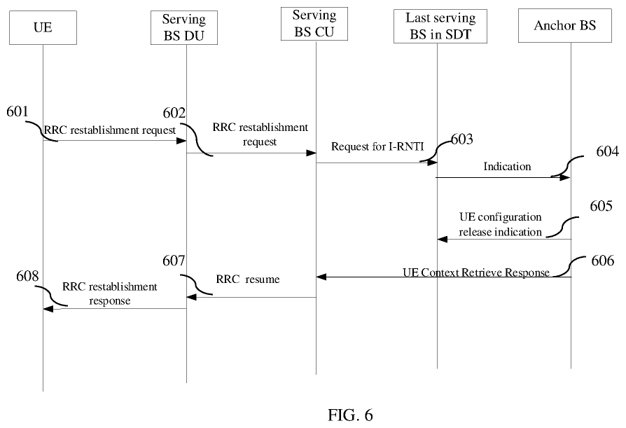

FIG. 6 illustrates a flow chart of a RRC reestablishment procedure according to some embodiments of the present application. The RRC reestablishment procedure is triggered in the non-SDT RACH procedure, in the RACH based SDT procedure, or in the CG based SDT procedure. The method in FIG. 6 is performed among a UE, a serving BS (including a distributed unit (DU) of the serving BS and a central unit (CU) of the serving BS), an anchor BS and a last serving BS in SDT. The serving BS indicates the BS with the serving cell. The last serving BS indicates the BS with the last serving cell.

Most steps in FIG. 6 are similar with those in FIG. 5, and these steps will not be described here in detail.

As shown in FIG. 6, in step 601, the UE may transmit an RRC reestablishment request to the serving BS DU.

In step 602 the serving BS DU transmits the RRC reestablishment request to the CU of the serving BS CU.

In step 603, after receiving the RRC resume request, the serving BS CU may transmits a request for an I-RNTI of the UE to the last serving BS in SDT (that is, a BS with the last serving cell in an SDT procedure) based on the ID of the last serving cell (PCell ID). The request for the I-RNTI of the UE includes a C-RNTI of the UE in the last serving cell and the PCell ID. The last serving cell is the cell where the UE performed the SDT procedure.

After receiving the request for an I-RNTI of the UE, in step 604, the last serving BS in SDT transmits an indication on an RRC reestablishment request of the serving BS to an anchor BS, if the last serving BS is not the anchor BS.

The indication on the RRC reestablishment request of the serving BS is implicitly indicated by an ID of the serving BS, an ID of the last serving cell and the C-RNTI of the UE in the last serving BS. The indication on the RRC reestablishment request may be transmitted in a retrieve UE context request message. Furthermore, the retrieve UE context request message may further include the I-RNTI, the cell ID of the last serving cell and/or resume cause value. The resume cause value could be at least one of an RLF in SDT; a random access problem; achieving of maximum number of retransmission in RLC; a beam failure recovery failure; a listen before talk (LBT) failure; and resume/reestablish the SDT DRB and/or SRB. In another example, the retrieve UE context request message may include null I-RNTI information.

The steps 605-608 in FIG. 6 are the same as steps 506-509 in FIG. 5, which will not be described here.

In some embodiments, if the UE determines to send the RRCResumeRequest to the serving BS to resume the RRC connection if the RLF happened in SDT procedure, the UE should do the unified access control (UAC) procedure, but there is no UAC response for RLF. Therefore, a new UAC category for RRC connection resumption triggered by RLF in SDT is needed.

Generally, a new access category could be allocated to the RLF in SDT based the RRC connection resumption, it could be a value similar to the UAC category of radio access network-based notification area (RNA)-updating. Or the access category for the RLF triggered resumption could reuse the category of the service UE decides to resume.

The UE may store an access category for RLF in the SDT procedure based RRC connection resumption, and performs access control by applying the AC in an RRC connection resumption procedure.

For example, the access category for RLF in the SDT procedure is a value the same as a unified access control (UAC) category of RNA-updating, or the access category for RLF in the SDT procedure reuses access category of service which the UE decides to resume, or the access category for RLF in the SDT procedure reuses access category used in SDT procedure when RLF is triggered.

In an example, the access category for RLF in the SDT procedure is a new value allocated to the RLF in SDT.

More details are as follows:
Upon initiation of the procedure, the UE shall:
   1> if the resumption of the RRC connection is triggered by response to rlc-MaxNumRetx or RLF in SD:
      2> select ‘X’ as the Access Category;
      2> perform the unified access control procedure as specified in 5.3.14 using the selected Access Category and one or more Access Identities provided by upper layers;
         3> if the access attempt is barred, the procedure ends

In another example, the access category for RLF in the SDT procedure reuses access category of service which the UE decides to resume.

More details are as follows:
Upon initiation of the procedure, the UE shall:
   1> if the resumption of the RRC connection is triggered by response to rlc-MaxNumRetx or RLF in SDT:
      2> select the Access Category based on the service UE decides to resume;
      2> perform the unified access control procedure as specified in 5.3.14 using the selected Access Category and one or more Access Identities provided by upper layers;
         3> if the access attempt is barred, the procedure ends.

In another example, the access category for RLF in the SDT procedure reuses access category used in SDT procedure when RLF is triggered.

More details are as follows:
1> if the resumption of the RRC connection is triggered due to an rlc-Max NumRetx or RLF in SDT or RNA updating as specified in 5.3.13.8:
   2> if an emergency service is ongoing:
NOTE: How the RRC layer in the UE is aware of an ongoing emergency service is up to UE implementation.
   3> select ‘2’ as the Access Category;
   3> set the resumeCause to emergency;
   2> else:
      3> select ‘8’ as the Access Category;
   2> perform the unified access control procedure as specified in 5.3.14 using the selected Access Category and one or more Access Identities to be applied as specified in TS 24.501 [23].

In some embodiments, when a RLF happens in a SDT procedure, the UE transmits a request message to request resumption or reestablishment of a data radio bearer (DRB) or a signaling radio bearer (SRB) in SDT procedure, and an explicit or implicit indication is included in the request message.

Furthermore, the UE still stays in an inactive mode in response to a reception of a response message for the request message.

The request message is different from the legacy RRC Resume (or Reestablishment) Request for SDT or for UE in connected mode. It could include the further information.

For example, the implicit indication includes a first RNTI of the UE being used in the last SDT procedure to monitor physical downlink control channel (PDCCH) and I-RNTI value in UE inactive mode. The I-RNTI value could be ShortI-RNTI-Value. The first RNTI is a C-RNTI used in a CG based SDT procedure, a C-RNTI used in a RACH based SDT procedure, or a configured scheduling (CS)-RNTI used in an CG based SDT procedure. Based on this C-RNTI, target cell/CG cell could find the UE context in inactive mode/UE context in SDT procedure.

For network, once the BS receives this message, it will re-establish the SRB/DRB used in UE inactive mode for SDT procedure. One Response message will be transmitted. Target cell (or serving cell) will retrieve the UE context and SRB/DRB used in SDT procedure as in RRC re-establishment procedure.

In an embodiment, a new timer will be introduced for this message, which is likely to the timer T301. For example, the UE will starts the new timer after the request message, the RRC reestablishment request message, or the RRC resume request message is transmitted. In particular, a new timer A will be introduced for the request message. A new timer B will be introduced for the RRC reestablishment request message. A new timer C will be introduced for the RRC resume request message.

Furthermore, the UE enters an idle mode if the UE does not receive a response message before the timer expires, or enters an inactive mode to perform a suspend operation in an SDT procedure if the UE does not receive a response message before the timer expires.

In some other embodiments, when a RLF happens in a SDT procedure, the UE may suspend the DRB or the SRB in SDT and enter an inactive mode; release the DRB or the SRB in SDT and entering an idle mode; or suspend the DRB or the SRB in SDT and sending an RRC resume request for SDT.

In some embodiments of the present application, in a RRC reestablishment procedure or a RRC resume procedure, a security processing will be performed.

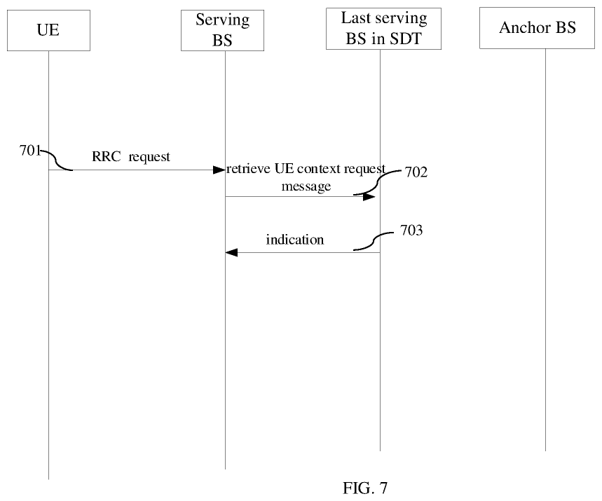

FIG. 7 illustrates a flow chart of performing security processing according to an embodiment of the present application. The method in FIG. 7 is performed among a UE, a serving BS, a last serving BS in SDT and an anchor BS. The serving BS indicates the BS with the serving cell. The last serving BS indicates the BS with the last serving cell.

As shown in FIG. 7, in step 701, the UE may transmit an RRC request to the serving BS. The RRC request may be an RRC reestablishment request, an RRC resume request or a request message. The RRC request may include C-RNTI of the UE, a token and an ID of a a source cell, or the I-RNTI, a token and ID of the PCell the UE was connected to prior to the failure. In this embodiment, the token in the RRC request needs to be verified. The RRC reestablishment request may include an I-RNTI of the UE or may not include an I-RNTI of the UE.

In step 702, the serving BS may transmit a retrieve UE context request message to the last serving BS in SDT.

The retrieve UE context request message includes a resume cause, and the resume cause value includes information of at least one of the following: an RLF in SDT; a random access problem; achieving of maximum number of retransmission in RLC; a beam failure recovery failure; a listen before talk (LBT) failure; and resume/reestablish a DRB and/or SRB for SDT.

Furthermore, the retrieve UE context request message may further include C-RNTI of the UE, a token and an ID of a target cell to last serving BS. Or retrieve UE context request message may include C-RNTI of the UE, a token and an ID of a source cell and or ID of the PCell the UE was connected to prior to the failure to the anchor gNB.

The serving BS transmits the C-RNTI of the UE, a token and an ID of a target cell to the last serving BS in SDT, so that the last serving BS may validate the UE request and give the indication on UE request validation to the serving BS or anchor gNB

In particular, the last serving BS store the UE's KeNB and/or the AS algorithms used in last serving cell, so that the last serving BS may validate the UE request (that is, the RRC request from the UE). And then in step 703, the last serving BS transmits the indication on UE request validation to the serving BS.

Furthermore, the serving BS may receive an unused chaining counter parameter (NCC) information of the UE from the anchor BS or receive an unused NCC information of the UE from the BS with the last serving cell. This case is applicable to accepting the RRC reestablishment procedure from the UE.

In another embodiment, the serving BS may receive a used chaining counter parameter (NCC) information of the UE from the anchor BS or receiving a used NCC information of the UE from the BS with the last serving cell. This case is applicable to accepting the RRC resume procedure from UE, where the UE already has derived the key with the stored (NH, NCC) pair during the RRC resume procedure.

In an embodiment, the last serving BS in SDT may transmit an unused chaining counter parameter (NCC) information of the UE to the anchor BS or receive an unused NCC information of the UE from the anchor BS.

In another embodiment, the last serving BS in SDT may transmit a used chaining counter parameter (NCC) information of the UE to the anchor BS or receive a used NCC information of the UE from the anchor BS.

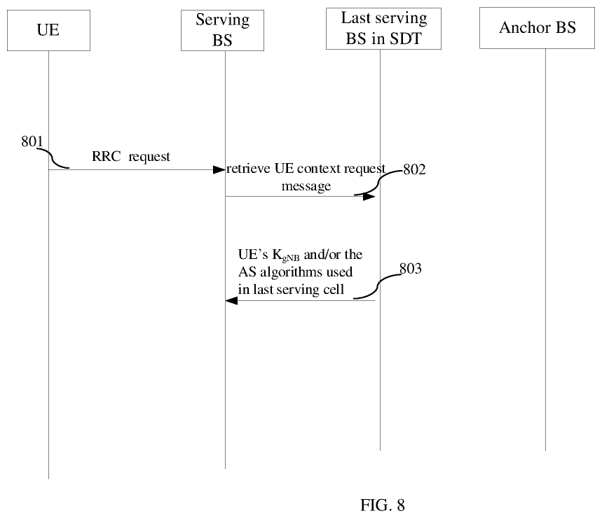

FIG. 8 illustrates a flow chart of performing security processing according to another embodiment of the present application. The method in FIG. 8 is performed among a UE, a serving BS, a last serving BS in SDT and an anchor BS. The serving BS indicates the BS with the serving cell. The last serving BS indicates the BS with the last serving cell.

As shown in FIG. 8, in step 801, the UE may transmit an RRC request to the serving BS. The RRC request may be an RRC reestablishment request, an RRC resume request or a request message. The RRC request may include C-RNTI of the UE, a token and an ID of a source cell, or the I-RNTI, a token and ID of the PCell the UE was connected to prior to the failure. In this embodiment, the token in the RRC request needs to be verified. The RRC reestablishment request may include an I-RNTI of the UE or may not include an I-RNTI of the UE.

In step 802, the serving BS may transmit a retrieve UE context request message to the last serving BS in SDT. The retrieve UE context request message may further include C-RNTI of the UE, a token and an ID of a target cell.

In step 803, the last serving BS in SDT may transmit the UE's KeNB and/or the AS algorithms used in last serving cell to the serving BS. And then the serving BS may perform validation on the RRC request based on the UE's KeNB and/or the AS algorithms used in last serving cell from the last serving BS in SDT.

Furthermore, the serving BS may receive an unused chaining counter parameter (NCC) information of the UE from the anchor BS or receive an unused NCC information of the UE from the BS with the last serving cell. This case is applicable to accepting the RRC reestablishment procedure from the UE.

In another embodiment, the serving BS may receive a used next Hop chaining counter parameter (NCC) information of the UE from the anchor BS or receiving a used NCC information of the UE from the BS with the last serving cell. This case is applicable to accepting the RRC resume procedure from UE, where the UE already has derived the key with the stored (NH, NCC) pair during the RRC resume procedure.

In an embodiment, the last serving BS in SDT may transmit an unused chaining counter parameter (NCC) information of the UE to the anchor BS or receive an unused NCC information of the UE from the anchor BS.

In another embodiment, the last serving BS in SDT may transmit a used chaining counter parameter (NCC) information of the UE to the anchor BS or receive a used NCC information of the UE from the anchor BS.

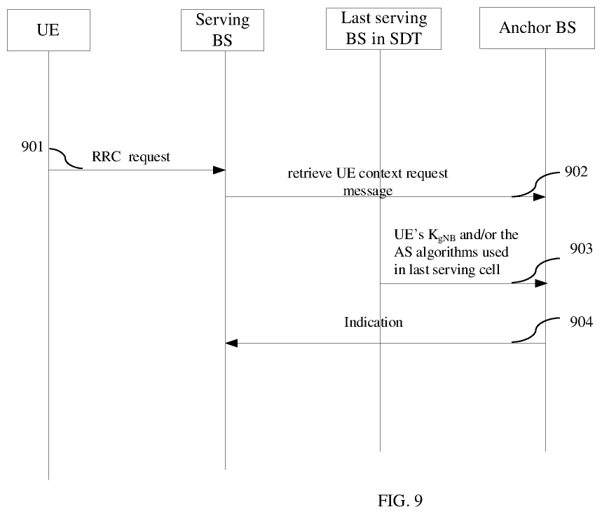

FIG. 9 illustrates a flow chart of performing security processing according to another embodiment of the present application. The method in FIG. 9 is performed among a UE, a serving BS, a last serving BS in SDT and an anchor BS. The serving BS indicates the BS with the serving cell. The last serving BS indicates the BS with the last serving cell.

As shown in FIG. 9, in step 901, the UE may transmit an RRC request to the serving BS. The RRC request may be an RRC reestablishment request, an RRC resume request or a request message. The RRC request may include C-RNTI of the UE, a token and an ID of a source cell, or the I-RNTI, a token and ID of the PCell the UE was connected to prior to the failure.

In this embodiment, the token in the RRC request needs to be verified. The RRC reestablishment request may include an I-RNTI of the UE or may not include an I-RNTI of the UE.

In step 902, the serving BS may transmit a retrieve UE context request message to the anchor BS. The retrieve UE context request message may include C-RNTI of the UE, a token and an ID of a target cell.

After receiving the retrieve UE context request message from the serving BS, the anchor BS may transmit a request for the UE's K_{gNB} and/or the AS algorithms used in last serving cell. In response to the request, in step 903, the last serving BS in SDT transmits the UE's K_{gNB} and/or the AS algorithms used in last serving cell to the anchor BS. And then the anchor BS may validate the UE request (that is, the RRC request from the UE) based on the received UE's K_{gNB} and/or the AS algorithms used in last serving cell.

And then in step 904, the anchor BS transmits the indication on UE request validation to the serving BS. For example, the indication on the UE request validation may be transmitted in a retrieve UE context response message. Or the transmitting of a retrieve UE context response message implicitly confirm the UE request validation.

Furthermore, the serving BS may receive an unused chaining counter parameter (NCC) information of the UE from the anchor BS or receive an unused NCC information of the UE from the BS with the last serving cell. This case is applicable to accepting the RRC reestablishment procedure from the UE.

In a embodiment, the NCC will be transmitted with the NH parameter from one BS to another BS.

In another embodiment, the serving BS may receive a used chaining counter parameter (NCC) information of the UE from the anchor BS or receiving a used NCC information of the UE from the BS with the last serving cell. This case is applicable to accepting the RRC resume procedure from UE, where the UE already has derived the key with the stored (NH, NCC) pair during the RRC resume procedure.

In an embodiment, the last serving BS in SDT may transmit an unused chaining counter parameter (NCC) information of the UE to the anchor BS or receive an unused NCC information of the UE from the anchor BS.

In another embodiment, the last serving BS in SDT may transmit a used chaining counter parameter (NCC) information of the UE to the anchor BS or receive a used NCC information of the UE from the anchor BS.

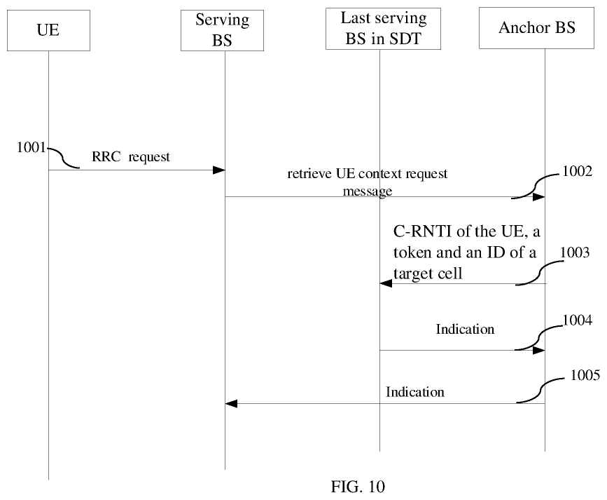

FIG. 10 illustrates a flow chart of performing security processing according to another embodiment of the present application. The method in FIG. 10 is performed among a UE, a serving BS, a last serving BS in SDT and an anchor BS. The serving BS indicates the BS with the serving cell. The last serving BS indicates the BS with the last serving cell.

As shown in FIG. 10, in step 1001, the UE may transmit an RRC request to the serving BS. The RRC request may be an RRC reestablishment request, an RRC resume request or a request message. The RRC request may include C-RNTI of the UE, a token and an ID of a a source cell, or the I-RNTI, a token and ID of the PCell the UE was connected to prior to the failure. In this embodiment, the token in the RRC request needs to be verified. The RRC reestablishment request may include an I-RNTI of the UE or may not include an I-RNTI of the UE.

In step 1002, the serving BS may transmit a retrieve UE context request message to the anchor BS. The retrieve UE context request message may include C-RNTI of the UE, a token and an ID of a target cell.

After receiving the retrieve UE context request message from the serving BS, in step 1003, the anchor BS may transmit the C-RNTI of the UE, a token and an ID of a target cell to the last serving BS in SDT.

The last serving BS store the UE's KeNB and/or the AS algorithms used in last serving cell, so that the last serving BS may validate the UE request (that is, the RRC request from the UE). And then in step 1004, the last serving BS transmits the indication on UE request validation to the anchor BS.

And then in step 1005, the anchor BS may transmits the received indication on UE request validation to the serving BS. For example, the indication on the UE request validation may be transmitted in a retrieve UE context response message.

Furthermore, the serving BS may receive an unused chaining counter parameter (NCC) information of the UE from the anchor BS or receive an unused NCC information of the UE from the BS with the last serving cell. This case is applicable to accepting the RRC reestablishment procedure from the UE.

In another embodiment, the serving BS may receive a used chaining counter parameter (NCC) information of the UE from the anchor BS or receiving a used NCC information of the UE from the BS with the last serving cell. This case is applicable to accepting the RRC resume procedure from UE, where the UE already has derived the key with the stored (NH, NCC) pair during the RRC resume procedure.

In an embodiment, the last serving BS in SDT may transmit an unused chaining counter parameter (NCC) information of the UE to the anchor BS or receive an unused NCC information of the UE from the anchor BS.

In another embodiment, the last serving BS in SDT may transmit a used chaining counter parameter (NCC) information of the UE to the anchor BS or receive a used NCC information of the UE from the anchor BS.

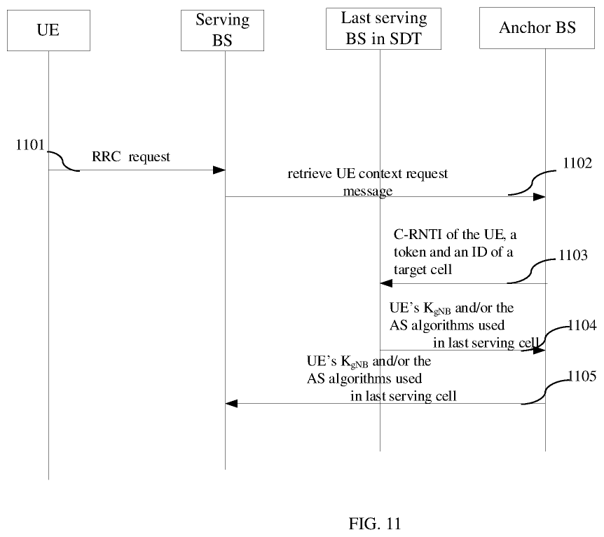

FIG. 11 illustrates a flow chart of performing security processing according to another embodiment of the present application. The method in FIG. 11 is performed among a UE, a serving BS, a last serving BS in SDT and an anchor BS. The serving BS indicates the BS with the serving cell. The last serving BS indicates the BS with the last serving cell.

As shown in FIG. 11, in step 1101, the UE may transmit an RRC request to the serving BS. The RRC request may be an RRC reestablishment request, an RRC resume request or a request message. The RRC request may include C-RNTI of the UE, a token and an ID of a source cell, or the I-RNTI, a token and ID of the PCell the UE was connected to prior to the failure. In this embodiment, the token in the RRC request needs to be verified. The RRC reestablishment request may include an I-RNTI of the UE or may not include an I-RNTI of the UE.

In step 1102, the serving BS may transmit a retrieve UE context request message to the anchor BS. The retrieve UE context request message may include C-RNTI of the UE, a token and an ID of a target cell.

After receiving the retrieve UE context request message from the serving BS, in step 1103, the anchor BS may transmit the C-RNTI of the UE, a token and an ID of a target cell to the last serving BS in SDT.

The last serving BS store the UE's KeNB and/or the AS algorithms used in last serving cell. In step 1104, the last serving BS in SDT transmits the UE's KeNB and/or the AS algorithms used in last serving cell to the anchor BS.

And then in 1105, the anchor BS transmits the UE's KeNB and/or the AS algorithms used in last serving cell to the serving BS. For example, the UE's K_{gNB} and/or the AS algorithms used in last serving cell may be transmitted in a retrieve UE context response message.

After receiving the UE's K_{gNB} and/or the AS algorithms used in last serving cell, the serving BS may validate the UE request (that is, the RRC request from the UE).

Furthermore, the serving BS may receive an unused chaining counter parameter (NCC) information of the UE from the anchor BS or receive an unused NCC information of the UE from the BS with the last serving cell. This case is applicable to accepting the RRC reestablishment procedure from the UE.

In another embodiment, the serving BS may receive a used chaining counter parameter (NCC) information of the UE from the anchor BS or receiving a used NCC information of the UE from the BS with the last serving cell. This case is applicable to accepting the RRC resume procedure from UE, where the UE already has derived the key with the stored (NH, NCC) pair during the RRC resume procedure.

In an embodiment, the last serving BS in SDT may transmit an unused chaining counter parameter (NCC) information of the UE to the anchor BS or receive an unused NCC information of the UE from the anchor BS.

In another embodiment, the last serving BS in SDT may transmit a used chaining counter parameter (NCC) information of the UE to the anchor BS or receive a used NCC information of the UE from the anchor BS.

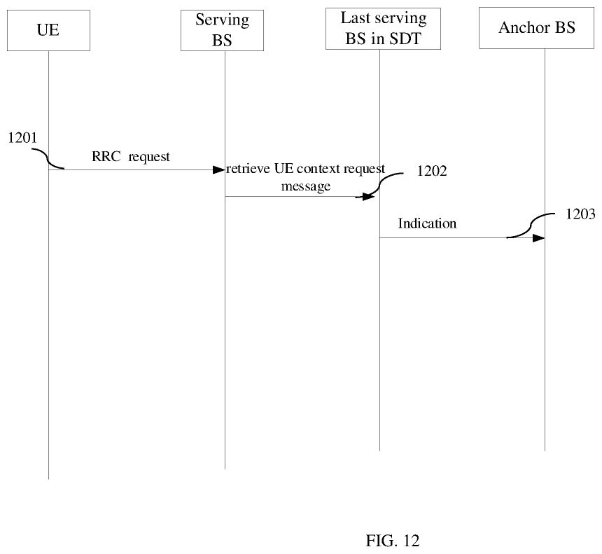

FIG. 12 illustrates a flow chart of performing security processing according to another embodiment of the present application. The method in FIG. 12 is performed among a UE, a serving BS, a last serving BS in SDT and an anchor BS. The serving BS indicates the BS with the serving cell. The last serving BS indicates the BS with the last serving cell.

As shown in FIG. 12, in step 1201, the UE may transmit an RRC request to the serving BS. The RRC request may be an RRC reestablishment request, an RRC resume request or a request message. The RRC request may include C-RNTI of the UE, a token and an ID of a target a source cell, or the I-RNTI, a token and ID of the PCell the UE was connected to prior to the failure. In this embodiment, the token in the RRC request needs to be verified. The RRC reestablishment request may include an I-RNTI of the UE or may not include an I-RNTI of the UE.

In step 1202, the serving BS may transmit a retrieve UE context request message to the last serving BS in SDT. The retrieve UE context request message may include C-RNTI of the UE, a token and an ID of a target cell.

After receiving the retrieve UE context request message from the serving BS, the last serving BS validate the UE request (that is, the RRC request from the UE). The last serving BS stores the UE's K_{gNB} and/or the AS algorithms used in last serving cell.

In step 1203, the last serving BS in SDT transmits the indication on UE request validation to the anchor BS.

Furthermore, the serving BS may receive an unused chaining counter parameter (NCC) information of the UE from the anchor BS or receive an unused NCC information of the UE from the BS with the last serving cell. This case is applicable to accepting the RRC reestablishment procedure from the UE.

In another embodiment, the serving BS may receive a used chaining counter parameter (NCC) information of the UE from the anchor BS or receiving a used NCC information of the UE from the BS with the last serving cell. This case is applicable to accepting the RRC resume procedure from UE, where the UE already has derived the key with the stored (NH, NCC) pair during the RRC resume procedure.

In an embodiment, the last serving BS in SDT may transmit an unused chaining counter parameter (NCC) information of the UE to the anchor BS or receive an unused NCC information of the UE from the anchor BS.

In another embodiment, the last serving BS in SDT may transmit a used chaining counter parameter (NCC) information of the UE to the anchor BS or receive a used NCC information of the UE from the anchor BS.

It should be understood that the retrieve UE context request message in FIGS. 7-12 is just an example, and it may be replaced by other message which can be transmitted between the BSs.

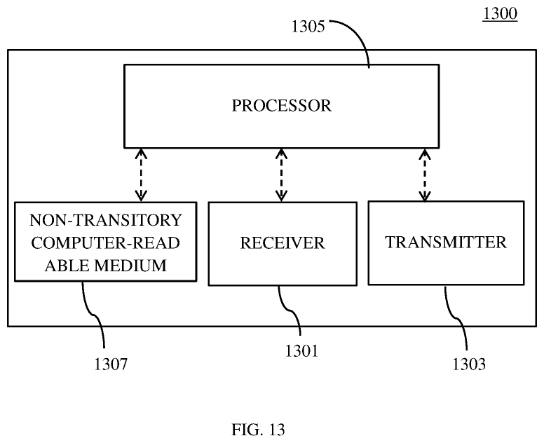

FIG. 13 illustrates an apparatus according to some embodiments of the present application. In some embodiments of the present application, the apparatus 300 may be the UE 101 as illustrated in FIG. 1 or other embodiments of the present application.

As shown in FIG. 13, the apparatus 1300 may include a receiver 1301, a transmitter 1303, a processer 1305, and a non-transitory computer-readable medium 1307. The non-transitory computer-readable medium 1307 has computer executable instructions stored therein. The processer 1305 is configured to be coupled to the non-transitory computer readable medium 1307, the receiver 1301, and the transmitter 1303. It can be contemplated that the apparatus 1300 may include more computer-readable mediums, receiver, transmitters and processors in some other embodiments of the present application according to practical requirements. In some embodiments of the present application, the receiver 1301 and the transmitter 1303 can be integrated into a single device, such as a transceiver. In certain embodiments, the apparatus 1300 may further include an input device, a memory, and/or other components.

In some embodiments of the present application, the non-transitory computer-readable medium 1307 may have stored thereon computer-executable instructions to cause the apparatus 1300 to implement the method according to embodiments of the present application.

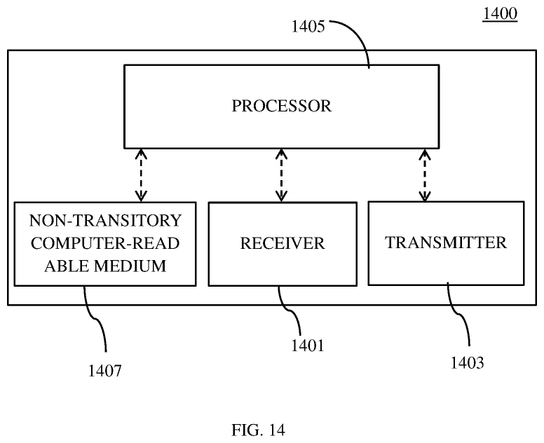

FIG. 14 illustrates another apparatus according to some embodiments of the present application. In some embodiments of the present application, the apparatus 1400 may be the BS 102 as illustrated in FIG. 1 or other embodiments of the present application.

As shown in FIG. 14, the apparatus 1400 may include a receiver 1401, a transmitter 1403, a processer 1405, and a non-transitory computer-readable medium 1407. The non-transitory computer-readable medium 1407 has computer executable instructions stored therein. The processer 1405 is configured to be coupled to the non-transitory computer readable medium 1407, the receiver 1401, and the transmitter 1403. It is contemplated that the apparatus 1400 may include more computer-readable mediums, receiver, transmitters and processors in some other embodiments of the present application according to practical requirements. In some embodiments of the present application, the receiver 1401 and the transmitter 1403 can be integrated into a single device, such as a transceiver. In certain embodiments, the apparatus 1400 may further include an input device, a memory, and/or other components.

In some embodiments of the present application, the non-transitory computer-readable medium 1407 may have stored thereon computer-executable instructions to cause the apparatus 1400 to implement the method according to embodiments of the present application.

Persons skilled in the art should understand that as the technology develops and advances, the terminologies described in the present application may change, and should not affect or limit the principle and spirit of the present application.

Those having ordinary skill in the art would understand that the steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including.” “having,” and the like, as used herein, are defined as “comprising.”

1. A user equipment (UE), comprising:
at least one memory; and
at least one processor coupled with the at least one memory and configured to cause the UE to:
determine a radio link failure (RLF) happens in a small data transmission (SDT) procedure; and
perform a procedure in response to the happening of the RLF in an SDT procedure.

2. The UE of claim 1, wherein the at least one processor is configured to cause the UE to have the following happen:
expiry of a timer;
a random access problem;
achieving of maximum number of retransmission in radio link control (RLC);
a beam failure recovery failure;
a listen before talk (LBT) failure;
or a combination thereof.

3. The UE of claim 1, wherein the RLF happens in the SDT procedure, and performing the procedure comprises: triggering a radio resource control (RRC) resume procedure in a non-SDT random access channel (RACH) procedure, triggering an RRC resume procedure in a RACH based SDT procedure or a configured grant (CG) based SDT procedure, triggering an RRC reestablishment procedure in a non-SDT RACH procedure, or triggering an RRC reestablishment procedure in a RACH based SDT procedure or a CG based SDT procedure.

4. The UE of claim 1, wherein the at least one processor is configured to cause the UE to perform actions so that:
the RLF happens in a configured grant (CG) based SDT procedure, and performing the procedure comprises: triggering a random access channel (RACH) based SDT procedure, wherein the RACH based SDT procedure is a 2-step RACH based SDT procedure or a 4-step RACH based SDT procedure;
the RLF happens in a 2-step RACH based SDT procedure, and performing the procedure comprises: triggering a 4-step RACH based SDT procedure;
the RLF happens in a 4-step RACH based SDT procedure, and performing the procedure comprises: triggering a radio resource control (RRC) resume procedure in a non-SDT RACH procedure or triggering an RRC reestablishment procedure in a non-SDT RACH procedure;
the RLF happens in a SDT procedure, and performing the procedure comprises: triggering an RRC resume procedure in a non-SDT RACH procedure or triggering an RRC reestablishment procedure in a non-SDT RACH procedure;
the RLF happens in a SDT procedure, the UE performs fallback to following procedure in an order of priority of: a CG based SDT procedure, a 2-step RACH based SDT procedure, a 4-step RACH based SDT procedure, a 2-step RACH based procedure, a 4-step RACH based procedure if the corresponding procedure is available to the UE;
or a combination thereof

5. The UE of claim 3, wherein triggering the RRC resume procedure in the non-SDT RACH procedure, in the RACH based SDT procedure, or in the CG based SDT procedure comprises:
transmitting an RRC resume request to a serving base station (BS),
wherein the RRC resume request includes an inactive-radio network temporary identifier (I-RNTI) of the UE and a resume cause value.

6. The UE of claim 5, wherein the resume cause value includes information of:
an RLF in SDT;
a random access problem;
achieving of maximum number of retransmission in radio link control (RLC);
a beam failure recovery failure;
a listen before talk (LBT) failure;
resume or reestablish a data radio bearer (DRB) and/or signaling radio bearer (SRB) for SDT;
or a combination thereof.

7. The UE of claim 3, wherein triggering the RRC reestablishment procedure in the non-SDT RACH procedure, in the RACH based SDT procedure, or in the CG based SDT procedure comprises:
transmitting an RRC reestablishment request to a serving BS,
wherein the RRC reestablishment request includes an inactive-radio network temporary identifier (I-RNTI) of the UE.

8. The UE of claim 7, wherein
a message authentication code-integrity (MAC-I) is included in the RRC reestablishment request, and is computed based on inputs of source-c-RNTI and sourcePhysCellId,
wherein the source-c-RNTI is set to cell-RNTI (C-RNTI) that the UE had in the a physical cell (PCell) it was connected to prior to the reestablishment,
wherein the sourcePhysCellId is set to a physical cell identity of the PCell the UE was connected to prior to the reestablishment, and the PCell is a cell the UE has service in the SDT procedure.

9. The UE of claim 5, wherein a message authentication code-integrity (MAC-I) is included in the RRC resume request and is transmitted based on inputs of source-c-RNTI and sourcePhysCellId,
wherein the source-c-RNTI is set to cell-RNTI (C-RNTI) that the UE had in a PCell it was connected in SDT procedure, or C-RNTI that the UE had in a PCell it was connected to prior to suspension of a SDT data radio bearer (DRB),
wherein the sourcePhysCellId is set to a physical cell identity of the serving Cell the UE was connected in SDT procedure, or the physical cell identity of the serving Cell the UE was connected to prior to suspension of the SDT DRB.

10. The UE of claim 1, wherein the at least one processor is configured to cause the UE to:
store an access category for RLF in a SDT procedure based RRC connection resumption; and
perform access control by applying the access category in an RRC connection resumption procedure.

11. The UE of claim 10, wherein the access category for RLF in the SDT procedure is a value the same as a unified access control (UAC) category of radio access network-based notification area (RNA)-updating, or the access category for RLF in the SDT procedure reuses an access category of service which the UE decides to resume, or the access category for RLF in the SDT procedure reuses an access category used in SDT procedure when RLF is triggered.

12. The UE of claim 1, wherein the at least one processor is configured to cause the UE to:
transmit a request message to request resumption or reestablishment of a data radio bearer (DRB) or a signaling radio bearer (SRB) in SDT procedure,
wherein an explicit or implicit indication is included in the request message.

13. A base station (BS), comprising:
at least one memory; and
at least one processor coupled with the at least one memory and configured to cause the BS to:
receive a radio resource control (RRC) request message with or without inactive-radio network temporary identifier (I-RNTI) of a user equipment (UE) from the UE, and
transmit a retrieve UE context request message to an anchor BS or a BS with the last serving cell.

14. The BS of claim 13, wherein, the at least one processor is configured to cause the BS to:
transmit cell-RNTI (C-RNTI) of the UE, a token and an identifier (ID) of a target cell to a BS with a last serving cell in the retrieve UE context request message to the BS with the last serving cell such that the BS with the last serving BS validates the token in the RRC request message and give a validation indication on the request to the BS with the serving cell or to an anchor BS; or
receive the UE's K_{gNB} and/or application server(AS) algorithms used in last serving cell from an anchor BS or from the BS with the last serving cell.

15. The BS of claim 14, wherein the at least one processor is configured to cause the BS to comprising:
receive a validation indication on the request from the anchor BS or from the BS with the last serving cell.

16. A processor for wireless communication, comprising:
at least one controller coupled with at least one memory and configured to cause the processor to:
determine a radio link failure (RLF) happens in a small data transmission (SDT) procedure; and
perform a procedure in response to the happening of the RLF in an SDT procedure.

17. A method performed by a user equipment (UE), the method comprising:
determining a radio link failure (RLF) happens in a small data transmission (SDT) procedure; and
performing a procedure in response to the happening of the RLF in an SDT procedure.

18. The method of claim 17, wherein determining the RLF happens comprises determining:
expiry of a timer;
a random access problem;
achieving of maximum number of retransmission in radio link control (RLC);
a beam failure recovery failure;
a listen before talk (LBT) failure;
or a combination thereof.

19. The method of claim 17, wherein the RLF happens in the SDT procedure, and performing the procedure comprises: triggering a radio resource control (RRC) resume procedure in a non-SDT random access channel (RACH) procedure, triggering an RRC resume procedure in a RACH based SDT procedure or a configured grant (CG) based SDT procedure, triggering an RRC reestablishment procedure in a non-SDT RACH procedure, or triggering an RRC reestablishment procedure in a RACH based SDT procedure or a CG based SDT procedure.

20. The method of claim 17, wherein performing the procedure comprises:
the RLF happens in a configured grant (CG) based SDT procedure, and performing the procedure comprises: triggering a random access channel (RACH) based SDT procedure, wherein the RACH based SDT procedure is a 2-step RACH based SDT procedure or a 4-step RACH based SDT procedure;
the RLF happens in a 2-step RACH based SDT procedure, and performing the procedure comprises: triggering a 4-step RACH based SDT procedure;
the RLF happens in a 4-step RACH based SDT procedure, and performing the procedure comprises: triggering a radio resource control (RRC) resume procedure in a non-SDT RACH procedure or triggering an RRC reestablishment procedure in a non-SDT RACH procedure;
the RLF happens in a SDT procedure, and performing the procedure comprises:
triggering an RRC resume procedure in a non-SDT RACH procedure or triggering an RRC reestablishment procedure in a non-SDT RACH procedure;
the RLF happens in a SDT procedure, the UE performs fallback to following procedure in an order of priority of: a CG based SDT procedure, a 2-step RACH based SDT procedure, a 4-step RACH based SDT procedure, a 2-step RACH based procedure, a 4-step RACH based procedure if the corresponding procedure is available to the UE;
or a combination thereof.
